(19) United States
(12) Patent Application Publication
(10) Pub. No.: US 2025/0303237 A1
(43) Pub. Date: Oct. 2, 2025

(54) GOLF BALL

(71) Applicant: Sumitomo Rubber Industries, Ltd., Kobe-shi (JP)

(72) Inventors: Ayaka SHINDO, Kobe-shi (JP); Takahiro SHIGEMITSU, Kobe-shi (JP); Kazuyoshi SHIGA, Kobe-shi (JP)

(73) Assignee: Sumitomo Rubber Industries, Ltd., Kobe-shi (JP)

(21) Appl. No.: 19/086,952

(22) Filed: Mar. 21, 2025

(30) Foreign Application Priority Data
Mar. 28, 2024 (JP) 2024-052687
Jul. 25, 2024 (JP) 2024-119487

(51) Int. Cl. A63B 37/00

(52) U.S. Cl. CPC A63B 37/0074; A63B 37/0031; A63B 37/0036

(57) ABSTRACT

An object of the present disclosure is, for a golf ball comprising a cover containing a polyurethane as a resin component, to improve the moldability of the cover and increase the productivity of the golf ball while suppressing lowering in the scratch resistance of the cover. The present disclosure provides a golf ball comprising a spherical core and a cover covering the spherical core, wherein the cover is formed from a cover composition containing (A) a thermoplastic polyurethane and (B) an olefin/unsaturated carboxylic acid copolymer and/or an olefin/unsaturated carboxylic acid/unsaturated carboxylic acid ester copolymer as a resin component, and an amount of (A) the thermoplastic polyurethane is 50 mass % or more in the resin component.

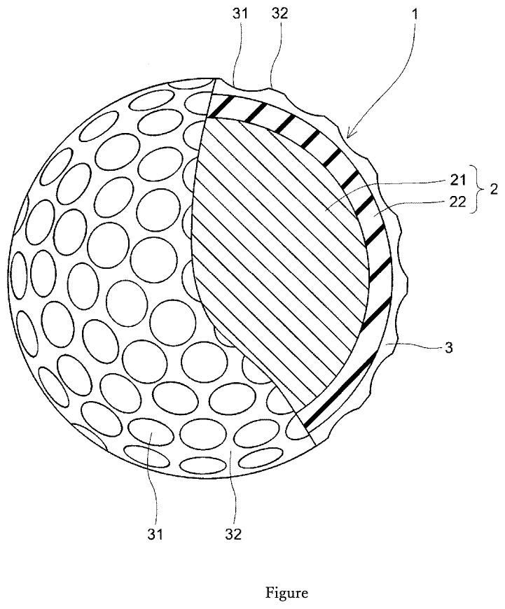

### FIELD OF THE DISCLOSURE

The present disclosure relates to a golf ball, and particularly relates to a technology for improving the moldability of a polyurethane cover.

### DESCRIPTION OF THE RELATED ART

Conventionally, as a resin component constituting a cover of a golf ball, an ionomer resin or a polyurethane is used. The ionomer cover tends to have excellent resilience, durability, processability or the like. The polyurethane cover tends to have improved shot feeling or spin performance. In addition, a cover material in which the ionomer resin and the polyurethane are used in combination is also proposed.

For example, JP H11-128402 A discloses a golf ball cover material containing a thermoplastic polyurethane elastomer, an ethylene/acrylic acid ester/glycidyl methacrylate ternary copolymer, and magnesium stearate.

JP 2003-180878 A discloses a cover composition primarily containing a heated mixture composed of 60 to 95 weight % of (a) a polyurethane thermoplastic elastomer and 5 to 40 weight % of (b) an ethylene/(meth)acrylic acid/(meth)acrylic acid ester ternary copolymer ionomer resin.

In addition, JP 2007-125377 A discloses a golf ball comprising a cover formed from a cover material, wherein the cover material primarily contains a heated mixture composed of 60 to 90 mass % of (A) a metal ion neutralized product of an olefin/unsaturated carboxylic acid copolymer and/or a metal ion neutralized product of an olefin/unsaturated carboxylic acid/unsaturated carboxylic acid ester copolymer (40 to 80 mass % of the component (A) is an ionomer neutralized with an alkali metal ion.), 5 to 20 mass % of (B) at least one member of an olefin/unsaturated carboxylic acid copolymer and/or an olefin/unsaturated carboxylic acid/unsaturated carboxylic acid ester copolymer, and 2 to 30 mass % of (C) a thermoplastic polyurethane elastomer.

### SUMMARY OF THE DISCLOSURE

When the polyurethane is primarily used as the resin component of the cover composition, there is a problem that the flowability of the cover composition tends to be low, and thus it is difficult to mold the cover. Here, the flowability of the cover composition is improved by adding the ionomer resin to the cover composition containing the polyurethane. However, if the ionomer resin is added to the polyurethane, there is a problem that the molded cover has lowered abrasion resistance.

The present disclosure has been made in view of the abovementioned circumstances, and an object of the present disclosure is to improve the moldability of the cover and increase the productivity of the golf ball while suppressing lowering in the abrasion resistance of the cover with respect to the golf ball comprising a cover containing a polyurethane as a resin component.

The present disclosure that has solved the above problem provides a golf ball comprising a spherical core and a cover covering the spherical core, wherein the cover is formed from a cover composition containing (A) a thermoplastic polyurethane and (B) an olefin/unsaturated carboxylic acid copolymer and/or an olefin/unsaturated carboxylic acid/unsaturated carboxylic acid ester copolymer as a resin component, and an amount of (A) the thermoplastic polyurethane is 50 mass % or more in the resin component.

According to the present disclosure, the moldability of the cover is improved and the productivity of the golf ball is increased while suppressing lowering in the abrasion resistance of the cover with respect to a golf ball comprising a cover containing a polyurethane as a resin component.

### BRIEF DESCRIPTION OF THE DRAWINGS

The FIGURE is a partially cutaway cross-sectional view showing a golf ball according to one embodiment of the present disclosure.

### DESCRIPTION OF THE PREFERRED EMBODIMENT

The present disclosure provides a golf ball comprising a spherical core and a cover covering the spherical core, wherein the cover is formed from a cover composition containing (A) a thermoplastic polyurethane and (B) an olefin/unsaturated carboxylic acid copolymer and/or an olefin/unsaturated carboxylic acid/unsaturated carboxylic acid ester copolymer as a resin component, and an amount of (A) the thermoplastic polyurethane is 50 mass % or more in the resin component.

If (B) the olefin/unsaturated carboxylic acid copolymer and/or the olefin/unsaturated carboxylic acid/unsaturated carboxylic acid ester copolymer is added to (A) the thermoplastic polyurethane, the flow starting temperature of the cover composition is lowered, and the melt viscosity of the cover composition becomes low, thus the moldability of the cover composition is improved. In addition, (B) the olefin/unsaturated carboxylic acid copolymer and/or the olefin/unsaturated carboxylic acid/unsaturated carboxylic acid ester copolymer hardly impairs the softness of (A) the thermoplastic polyurethane, thus lowering in the abrasion resistance of the obtained cover is suppressed.

### [Cover Composition]

The cover composition used in the present disclosure will be explained. The cover composition contains (A) a thermoplastic polyurethane and (B) an olefin/unsaturated carboxylic acid copolymer and/or an olefin/unsaturated carboxylic acid/unsaturated carboxylic acid ester copolymer as a resin component.

### ((A) Thermoplastic Polyurethane)

The cover composition contains (A) the thermoplastic polyurethane as the resin component.

(A) The thermoplastic polyurethane has a plurality of urethane bonds in the molecule and exhibits thermoplasticity. The thermoplastic polyurethane is a polyurethane exhibiting plasticity by heating and generally means a polyurethane having a linear chain structure of a high molecular weight to a certain extent. Examples of (A) the thermoplastic polyurethane include a reaction product having urethane bonds formed in the molecule by a reaction between a polyisocyanate and a polyol.

The polyisocyanate constituting (A) the thermoplastic polyurethane is not particularly limited, as long as the polyisocyanate is a compound having at least two isocyanate groups in the molecule. The polyisocyanate may be used solely, or at least two of them may be used in combination. The polyisocyanate is preferably a diisocyanate having two isocyanate groups in the molecule.

Examples of the polyisocyanate include an aromatic polyisocyanate such as 2,4-toluene diisocyanate, 2,6-toluene diisocyanate, a mixture of 2,4-toluene diisocyanate and 2,6-toluene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylenediisocyanate (TMXDI), and para-phenylene diisocyanate (PPDI); and an alicyclic polyisocyanate or aliphatic polyisocyanate such as 4,4′-dicyclohexylmethane diisocyanate (H₁₂MDI), 1,3-bis(isocyanatomethyl)cyclohexane (H₆XDI), hexamethylene diisocyanate (HDI), isophorone diisocyanate (IPDI), trans-1,4-cyclohexane diisocyanate (CHDI) and norbornene diisocyanate (NBDI). Among them, as the polyisocyanate, the alicyclic diisocyanate and/or the aromatic diisocyanate is preferable. If the alicyclic diisocyanate and/or the aromatic diisocyanate is used, the obtained polyurethane has enhanced mechanical properties, and the obtained cover has further enhanced abrasion resistance.

As the polyisocyanate of (A) the thermoplastic polyurethane, at least one member selected from the group consisting of 4,4′-dicyclohexylmethane diisocyanate (H₁₂MDI), 1,3-bis(isocyanatomethyl)cyclohexane (H₆XDI), isophorone diisocyanate (IPDI), trans-1,4-cyclohexane diisocyanate (CHDI), 4,4′-diphenylmethane diisocyanate (MDI) and toluene diisocyanate (TDI) is particularly preferable. If these diisocyanates are used, the obtained polyurethane has enhanced mechanical properties, and the obtained cover has further enhanced abrasion resistance.

In addition, as the polyisocyanate of (A) the thermoplastic polyurethane, the non-yellowing polyisocyanate (TMXDI, XDI, HDI, H₆XDI, IPDI, H₁₂MDI, NBDI, etc.) is preferably used, and 4,4′-dicyclohexylmethane diisocyanate (H₁₂MDI) is more preferably used, from the viewpoint of improving the weather resistance of the cover. The 4,4′-dicyclohexylmethane diisocyanate (H₁₂MDI) has a rigid structure, thus the obtained polyurethane has further enhanced mechanical properties.

The polyol constituting (A) the thermoplastic polyurethane is not particularly limited, as long as the polyol is a compound having at least two hydroxy groups in the molecule. Examples of the polyol include a high molecular weight polyol. The high molecular weight polyol may be used solely, or at least two of them may be used in combination. As the polyol, a diol having two hydroxy groups in the molecule is preferable.

Examples of the high molecular weight polyol include a polyether polyol such as polyoxyethylene glycol (PEG), polyoxypropylene glycol (PPG), polytrimethylene ether glycol (PO3G) and polyoxytetramethylene glycol (PTMG); a condensed polyester polyol such as polyethylene adipate (PEA), polybutylene adipate (PBA) and polyhexamethylene adipate (PHMA); a lactone polyester polyol such as poly-ε-caprolactone (PCL); a polycarbonate polyol such as polyhexamethylene carbonate; and an acrylic polyol. The high molecular weight polyol may derive from petroleum resources, or derive from biomass resources.

The number average molecular weight of the high molecular weight polyol is not particularly limited. For example, the number average molecular weight of the high molecular weight polyol is preferable 400 or more, more preferably 1,000 or more, and is preferably 10,000 or less, more preferably 8,000 or less.

(A) The thermoplastic polyurethane may have a chain extender as a constituent component. As the chain extender component, a low molecular weight polyol, a low molecular weight polyamine, or the like can be used.

Examples of the low molecular weight polyol include a diol such as ethylene glycol, diethylene glycol, triethylene glycol, propanediol (e.g. 1,2-propanediol, 1,3-propanediol, 2-methyl-1,3-propanediol, and the like), dipropylene glycol, butanediol (e.g. 1,2-butanediol, 1,3-butanediol, 1,4-butanediol, 2,3-butanediol, 2,3-dimethyl-2,3-butanediol, and the like), neopentyl glycol, pentanediol, hexanediol, heptanediol, octanediol, 1,6-cyclohexanedimethylol, aniline type diol, and bisphenol A type diol; a triol such as glycerin, trimethylolpropane, and hexanetriol; and a tetraol or a hexol such as pentaerythritol and sorbitol.

The low molecular weight polyamine used as the chain extender component is not particularly limited, as long as the low molecular weight polyamine has at least two amino groups. Examples of the polyamine include an aliphatic polyamine such as ethylene diamine, propylene diamine, butylene diamine and hexamethylene diamine; an alicyclic polyamine such as isophorone diamine and piperazine; and an aromatic polyamine.

The aromatic polyamine is not particularly limited, as long as it has at least two amino groups directly or indirectly bonded to an aromatic ring. Herein, the “indirectly bonded to an aromatic ring” means that the amino group is bonded to an aromatic ring via, for example, a lower alkylene group. The aromatic polyamine may be, for example, a monocyclic aromatic polyamine having at least two amino groups bonded to one aromatic ring, or a polycyclic aromatic polyamine having at least two aminophenyl groups each having at least one amino group bonded to one aromatic ring.

Examples of the monocyclic aromatic polyamine include a type wherein amino groups are directly bonded to an aromatic ring, such as phenylenediamine, tolylenediamine, diethyltoluenediamine, and dimethylthiotoluenediamine; and a type wherein amino groups are bonded to an aromatic ring via a lower alkylene group, such as xylylenediamine.

In addition, the polycyclic aromatic polyamine may be either a poly(aminobenzene) having at least two aminophenyl groups directly bonded to each other, or a compound having at least two aminophenyl groups bonded to each other via a lower alkylene group or an alkylene oxide group. Among them, a diaminodiphenylalkane having two aminophenyl groups bonded to each other via a lower alkylene group is preferable, 4,4′-diaminodiphenylmethane and a derivative thereof are particularly preferable.

The molecular weight of the chain extender is preferably less than 400, more preferably 350 or less, and even more preferably 200 or less, and is preferably 30 or more, more preferably 40 or more, and even more preferably 45 or more.

The constitution embodiment of (A) the thermoplastic polyurethane is not particularly limited, and examples thereof include an embodiment in which (A) the thermoplastic polyurethane is composed of the polyisocyanate and the high molecular weight polyol; an embodiment in which (A) the thermoplastic polyurethane is composed of the polyisocyanate, the high molecular weight polyol and the low molecular weight polyol; an embodiment in which (A) the thermoplastic polyurethane is composed of the polyisocyanate, the high molecular weight polyol, the low molecular weight polyol and the polyamine; and an embodiment in which (A) the thermoplastic polyurethane is composed of the polyisocyanate, the high molecular weight polyol and the polyamine. In particular, as the constitution embodiment of (A) the thermoplastic polyurethane, an embodiment in which (A) the thermoplastic polyurethane is composed of the diisocyanate and the diol is preferable, and an embodiment in which (A) the thermoplastic polyurethane is composed of the diisocyanate, the high molecular weight diol and the low molecular weight diol is more preferable.

The amount of the polyol in 100 mass % of (A) the thermoplastic polyurethane is preferably 10 mass % or more, more preferably 15 mass % or more, and even more preferably 20 mass % or more, and is preferably 90 mass % or less, more preferably 85 mass % or less, and even more preferably 80 mass % or less.

The amount of the polyisocyanate in 100 mass % of (A) the thermoplastic polyurethane is preferably 10 mass % or more, more preferably 15 mass % or more, and even more preferably 20 mass % or more, and is preferably 90 mass % or less, more preferably 85 mass % or less, and even more preferably 80 mass % or less.

The slab hardness of (A) the thermoplastic polyurethane is preferably 25 or more, more preferably 26 or more, and even more preferably 28 or more, and is preferably 40 or less, more preferably 39 or less, and even more preferably 38 or less in Shore D hardness. If the slab hardness of (A) the thermoplastic polyurethane is 25 or more in Shore D hardness, the spin rate on driver shots can be lowered, and if the slab hardness of (A) the thermoplastic polyurethane is 40 or less in Shore D hardness, the spin rate on approach shots increases.

The amount of (A) the thermoplastic polyurethane in the resin component is preferably 50 mass % or more, more preferably 55 mass % or more, even more preferably 60 mass % or more, and particularly preferably 80 mass % or more, and is preferably 99.9 mass % or less, more preferably 99 mass % or less, even more preferably 98 mass % or less, and most preferably 95 mass % or less. If the amount of the component (A) is 50 mass % or more, the cover has better abrasion resistance, and if the amount of the component (A) is 99.9 mass % or less, the cover composition has better moldability.

((B) Olefin/Unsaturated Carboxylic Acid Copolymer and/or the Olefin/Unsaturated Carboxylic Acid/Unsaturated Carboxylic Acid Ester Copolymer)

The cover composition contains (B) the olefin/unsaturated carboxylic acid copolymer and/or the olefin/unsaturated carboxylic acid/unsaturated carboxylic acid ester copolymer as the resin component. (B) The olefin/unsaturated carboxylic acid copolymer and/or the olefin/unsaturated carboxylic acid/unsaturated carboxylic acid ester copolymer may be used solely, or at least two of them may be used in combination.

The olefin/unsaturated carboxylic acid copolymer is a binary copolymer composed of an olefin and an unsaturated carboxylic acid (hereinafter, sometimes referred to as “(B1) the binary copolymer”). The olefin/unsaturated carboxylic acid/unsaturated carboxylic acid ester copolymer is a ternary copolymer composed of an olefin, an unsaturated carboxylic acid and an unsaturated carboxylic acid ester (hereinafter, sometimes referred to as “(B2) the ternary copolymer”). (B) The olefin/unsaturated carboxylic acid copolymer and/or the olefin/unsaturated carboxylic acid/unsaturated carboxylic acid ester copolymer may consist of (B1) the binary copolymer or consist of (B2) the ternary copolymer. In addition, (B1) the binary copolymer and (B2) the ternary copolymer may be used in combination.

The olefin is preferably an olefin having 2 to 8 carbon atoms, more preferably an olefin having 2 to 4 carbon atoms. Examples of the olefin include ethylene, propylene, butene, pentene, hexene, heptene and octene, and ethylene is particularly preferred.

As the unsaturated carboxylic acid, an α,β-unsaturated carboxylic acid is preferable, and an α,β-unsaturated carboxylic acid having 3 to 8 carbon atoms is more preferable. Examples of the unsaturated carboxylic acid include acrylic acid, methacrylic acid, fumaric acid, maleic acid and crotonic acid, and acrylic acid or methacrylic acid is particularly preferred.

As the unsaturated carboxylic acid ester, an α,β-unsaturated carboxylic acid ester is preferable, and an alkyl ester of an α,β-unsaturated carboxylic acid having 3 to 8 carbon atoms is more preferable. As the unsaturated carboxylic acid ester, an alkyl ester of acrylic acid, methacrylic acid, fumaric acid or maleic acid is more preferable, and the alkyl ester of acrylic acid or the alkyl ester of methacrylic acid is particularly preferable. Examples of the alkyl group constituting the ester include a methyl group, an ethyl group, a propyl group, an n-butyl group, and an isobutyl group. As the unsaturated carboxylic acid ester, methyl (meth)acrylate, ethyl (meth)acrylate, propyl (meth)acrylate, n-butyl (meth)acrylate, and isobutyl (meth)acrylate are preferable. It is noted that in the present disclosure, (meth)acrylic acid means acrylic acid and/or methacrylic acid.

As (B1) the binary copolymer, a binary copolymer composed of ethylene and an α,β-unsaturated carboxylic acid having 3 to 8 carbon atoms is preferable, and an ethylene/(meth)acrylic acid binary copolymer is more preferable.

As (B2) the ternary copolymer, a ternary copolymer composed of ethylene, an α,β-unsaturated carboxylic acid having 3 to 8 carbon atoms and an alkyl ester of an α,β-unsaturated carboxylic acid having 3 to 8 carbon atoms is preferable, an ethylene/(meth)acrylic acid/(meth)acrylic acid alkyl ester ternary copolymer is more preferable.

The amount of the unsaturated carboxylic acid component is preferably 1 mass % or more, more preferably 3 mass % or more, and even more preferably 5 mass % or more, and is preferably 50 mass % or less, more preferably 45 mass % or less, and even more preferably 40 mass % or less in (B1) the binary copolymer. If the amount of the unsaturated carboxylic acid component falls within the above range, (B1) the binary copolymer has better compatibility with (A) the thermoplastic polyurethane.

The amount of the unsaturated carboxylic acid component is preferably 1 mass % or more, more preferably 3 mass % or more, and even more preferably 5 mass % or more, and is preferably 50 mass % or less, more preferably 45 mass % or less, and even more preferably 40 mass % or less in (B2) the ternary copolymer. If the amount of the unsaturated carboxylic acid component falls within the above range, (B2) the ternary copolymer has better compatibility with (A) the thermoplastic polyurethane.

The melt flow rate (MFR) (190° C., 2.16 kgf) of (B) the olefin/unsaturated carboxylic acid copolymer and/or the olefin/unsaturated carboxylic acid/unsaturated carboxylic acid ester copolymer is preferably 10 g/10 min or more, more preferably 15 g/10 min or more, and even more preferably 25 g/10 min or more, and is preferably 1000 g/10 min or less, more preferably 900 g/10 min or less, and even more preferably 800 g/10 min or less. If the MFR (190° C., 2.16 kgf) of the component (B) is 10 g/10 min or more, the cover composition has better flowability. In addition, if the MFR (190° C., 2.16 kgf) of the component (B) is 1000 g/10 min or less, the obtained cover has better impact durability. The MFR is measured according to JIS K7210 with a flow tester. In the case that a plurality of components (B) are used in combination, the MFR of their mixture is measured.

The melting point of (B) the olefin/unsaturated carboxylic acid copolymer and/or the olefin/unsaturated carboxylic acid/unsaturated carboxylic acid ester copolymer is preferably 120° C. or less, more preferably 118° C. or less, and even more preferably 115° C. or less. The melting point of the component (B) is preferably 75° C. or more.

Examples of the component (B) include NUCREL (registered trademark) N2050H, N2060, N1050H, N1560, N1525, AN4221C, AN4213C, N1110H, AN4229C, N11081C, N1108C, N1035, N035C, N0908C, AN42012C, N0903HC, N0823, AN42115C, AN4228C, AN4214C, NO200H, AN4233C (available from Dow-Mitsui Polychemicals Co., Ltd.); and PRIMACOR (registered trademark) 1321, 1410, 1430, 3002, 3003, 3004, 3330, 3340, 3440, 3460 (available from SK Geo Centric).

The amount of (B) the olefin/unsaturated carboxylic acid copolymer and the olefin/unsaturated carboxylic acid/unsaturated carboxylic acid ester copolymer is preferably 0.1 mass % or more, more preferably 0.5 mass % or more, even more preferably 1 mass % or more, particularly preferably 3 mass % or more, and most preferably 5 mass % or more, and is preferably 50 mass % or less, more preferably 45 mass % or less, even more preferably 40 mass % or less, and particularly preferably 20 mass % or less in the resin component. If the amount of the component (B) is 0.1 mass % or more, the cover composition has further enhanced moldability, and if the amount of the component (B) is 50 mass % or less, lowering in the abrasion resistance of the obtained cover can be further lowered.

The mass ratio ((A)/(B)) of (A) the thermoplastic polyurethane to (B) the olefin/unsaturated carboxylic acid copolymer and the olefin/unsaturated carboxylic acid/unsaturated carboxylic acid ester copolymer in the resin component is preferably 50.0/50.0 or more, more preferably 55.0/45.0 or more, and even more preferably 60.0/40.0 or more, and is preferably 99.9/0.1 or less, more preferably 99.0/1.0 or less, and even more preferably 98.0/2.0 or less. If the mass ratio ((A)/(B)) is 50.0/50.0 or more, lowering in the abrasion resistance of the obtained cover is further suppressed, and if the mass ratio ((A)/(B)) is 99.9/0.1 or less, the cover composition has further enhanced moldability.

### (Other Resin Components)

The resin component of the cover composition may consist of (A) the thermoplastic polyurethane and (B) the olefin/unsaturated carboxylic acid copolymer and/or the olefin/unsaturated carboxylic acid/unsaturated carboxylic acid ester copolymer, or may contain other resin components in addition to the components (A) and (B).

Examples of the other resin components include a thermoplastic elastomer.

Specific examples of the thermoplastic elastomer include a thermoplastic polyamide elastomer such as “Pebax (registered trademark) (e.g. “Pebax 2533”)” available from Arkema K. K.; a thermoplastic polyester elastomer such as “Hytrel (registered trademark) (e.g. “Hytrel 3548”, “Hytrel 4047”)” available from Toray Celanese Co., Ltd.; and a thermoplastic polystyrene elastomer such as “Tefabloc (registered trademark)” available from Mitsubishi Chemical Corporation.

In the case that the other resin components are contained as the resin component in addition to the component (A) and the component (B), the total amount of the component (A) and the component (B) is preferably 85 mass % or more, more preferably 90 mass % or more, and even more preferably 95 mass % or more in the resin component.

### (Additives)

The cover composition may further contain a pigment component such as titanium oxide and a blue pigment, a weight adjusting agent such as calcium carbonate and barium sulfate, a dispersant, an antioxidant, an ultraviolet absorber, a light stabilizer, a fluorescent material or fluorescent brightener, or the like, as long as these additives don't impair the performance of the cover. The amount of the resin component in the cover composition is preferable 90 mass % or more, more preferably 92 mass % or more, and even more preferably 94 mass % or more.

The amount of the white pigment (e.g. titanium oxide) is preferably 0.5 part by mass or more, more preferably 1 part by mass or more, and even more preferably 1.5 parts by mass or more, and is preferably 10 parts by mass or less, more preferably 8 parts by mass or less, and even more preferably 6 parts by mass or less, with respect to 100 parts by mass of the resin component. If the amount of the white pigment is 0.5 part by mass or more, it is possible to impart the opacity to the cover, and if the amount of the white pigment is 10 parts by mass or less, the cover has better durability.

The cover composition preferably does not contain a basic metal compound for neutralizing the carboxy groups included in (B) the olefin/unsaturated carboxylic acid copolymer and/or the olefin/unsaturated carboxylic acid/unsaturated carboxylic acid ester copolymer. Examples of the metal included in the basic metal compound include lithium, sodium, potassium, calcium, magnesium, zinc, aluminum, nickel, iron, copper, manganese, tin, lead, and cobalt. Examples of the basic metal compound include magnesium oxide, magnesium hydroxide, magnesium carbonate, zinc oxide, sodium hydroxide, sodium carbonate, calcium oxide, calcium hydroxide, lithium hydroxide, lithium carbonate, and magnesium stearate.

The cover composition may be obtained, for example, by dry blending the component (A), the component (B), and other optional additives or the like that are blended where necessary. Further, the dry blended mixture may be extruded into a pellet form. In the dry blending, for example, a mixer capable of blending raw materials in a pellet form is preferably used, a tumbler type mixer is more preferably used. The extrusion can be carried out using a publicly known extruder such as a single-screw extruder, a twin-screw extruder, and a twin-screw/single-screw extruder.

The slab hardness of the cover composition is preferably 25 or more, more preferably 26 or more, and even more preferably 28 or more, and is preferably 40 or less, more preferably 39 or less, and even more preferably 38 or less in Shore D hardness. If the slab hardness is 25 or more in Shore D hardness, the spin rate on driver shots can be lowered, and if the slab hardness is 40 or less in Shore D hardness, the spin rate on approach shots increases.

The melt viscosity (190° C.) of the cover composition is preferably less than 3850 Pa·s, more preferably less than 3500 Pa·s. If the melt viscosity (190° C.) is less than 3850 Pa·s, the cover composition has further enhanced moldability. It is noted that the lower limit of the melt viscosity (190° C.) is not particularly limited, but the melt viscosity (190° C.) is preferably 10 Pas or more. The measurement method of the melt viscosity (190° C.) will be described later.

The flow starting temperature of the cover composition is preferably less than 110° C., more preferably less than 109° C. If the flow starting temperature is less than 110° C., the cover composition has further enhanced moldability. It is noted that the lower limit of the flow starting temperature is not particularly limited, but the flow starting temperature is preferably 70° C. or more. The measurement method of the flow starting temperature will be described later.

### [Golf Ball]

The golf ball according to the present disclosure comprises a spherical core and a cover covering the spherical core, wherein the cover is formed from the cover composition. The cover constitutes the outermost layer of the golf ball body. It is noted that the present disclosure relates to the moldability and abrasion resistance of the cover, and the constitution or the like of the spherical core is not limited.

### (Spherical Core)

Examples of the spherical core include a single layered spherical core; a spherical core composed of a center and one intermediate layer covering the center; and a spherical core composed of a center and at least two intermediate layers covering the center.

The spherical core can be formed from a conventional rubber composition (hereinafter sometimes simply referred to as “core rubber composition”). For example, the spherical core can be molded by heat pressing a rubber composition containing a base rubber, a co-crosslinking agent and a crosslinking initiator.

As the base rubber, particularly preferred is a high-cis polybutadiene having a cis bond in an amount of 40 mass % or more, preferably 70 mass % or more, and more preferably 90 mass % or more in view of its superior resilience.

As the co-crosslinking agent, an α,β-unsaturated carboxylic acid having 3 to 8 carbon atoms or a metal salt thereof is preferable, acrylic acid or a metal salt thereof and methacrylic acid or a metal salt thereof are more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. In a case that the α,β-unsaturated carboxylic acid having 3 to 8 carbon atoms is used as the co-crosslinking agent, a metal compound (e.g. magnesium oxide) is preferably added.

As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and even more preferably 0.4 part by mass or more, and is preferably 5 parts by mass or less, more preferably 4 parts by mass or less, and even more preferably 3 parts by mass or less, with respect to 100 parts by mass of the base rubber.

In addition, the core rubber composition may further contain an organic sulfur compound. As the organic sulfur compound, diphenyl disulfides, thiophenols or thionaphthols are preferably used. The amount of the organic sulfur compound is preferably 0.1 part by mass or more, more preferably 0.3 part by mass or more, and even more preferably 0.5 part by mass or more, and is preferably 5.0 parts by mass or less, more preferably 4.0 parts by mass or less, and even more preferably 2.0 parts by mass or less, with respect to 100 parts by mass of the base rubber.

The core rubber composition may further contain a carboxylic acid and/or a salt thereof. As the carboxylic acid and/or the salt thereof, a carboxylic acid having 1 to 30 carbon atoms and/or a salt thereof is preferable. The carboxylic acid may be either an aliphatic carboxylic acid or an aromatic carboxylic acid (such as benzoic acid). The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, a colored powder, or the like in addition to the base rubber, the co-crosslinking agent, the crosslinking initiator, and the organic sulfur compound.

The molding conditions for heat pressing the core rubber composition may be determined appropriately depending on the rubber composition. Generally, the heat pressing is preferably carried out at a temperature of 130° C. to 200° C. for 10 to 60 minutes, or carried out in a two-step heating of heating at a temperature of 130° C. to 150° C. for 20 to 40 minutes followed by heating at a temperature of 160° C. to 180° C. for 5 to 15 minutes.

In the case that the spherical core has an intermediate layer, examples of the intermediate layer material include a thermoplastic resin such as a polyurethane resin, an ionomer resin, a polyamide resin, and polyethylene; a thermoplastic elastomer such as a styrene elastomer, a polyolefin elastomer, a polyurethane elastomer, a polyamide elastomer, and a polyester elastomer; and a cured product of a rubber composition. Herein, examples of the ionomer resin include a product prepared by neutralizing at least a part of carboxyl groups in a binary copolymer composed of ethylene and an α,β-unsaturated carboxylic acid with a metal ion; and a product prepared by neutralizing at least a part of carboxyl groups in a ternary copolymer composed of ethylene, an α,β-unsaturated carboxylic acid and an α,β-unsaturated carboxylic acid ester with a metal ion. The intermediate layer may further contain a weight adjusting agent such as barium sulfate and tungsten, an antioxidant, and a pigment.

The method for forming the intermediate layer is not particularly limited, and examples thereof include a method which comprises molding the intermediate layer composition into hemispherical half shells in advance, covering the spherical body with two of the half shells, and subjecting the spherical body with two of the half shells to the compression molding; and a method which comprises injection molding the intermediate layer composition directly onto the spherical body so as to cover the spherical body.

In case of injection molding the intermediate layer composition onto the spherical body to form the intermediate layer, it is preferred to use upper and lower molds, each having a hemispherical cavity, for forming the intermediate layer. When molding the intermediate layer by the injection molding, the hold pin is protruded to hold the spherical body, and the heated and melted intermediate layer composition is charged and then cooled to obtain the intermediate layer.

When molding the intermediate layer in the compression molding method, molding of the half shell may be conducted by either a compression molding method or an injection molding method, and the compression molding method is preferable. The compression molding of the intermediate layer composition into the half shell can be carried out, for example, under a pressure of 1 MPa or more and 20 MPa or less at a temperature of −20° C. or more and 70° C. or less relative to the flow starting temperature of the intermediate layer composition. By performing the molding under the above conditions, a half shell having a uniform thickness can be formed. Examples of the method for molding the intermediate layer using half shells include a method of covering the spherical body with two of the half shells and then subjecting the spherical core with two of the half shells to the compression molding. The compression molding of the half shells into the intermediate layer can be carried out, for example, under a pressure of 0.5 MPa or more and 25 MPa or less at a temperature of −20° C. or more and 70° C. or less relative to the flow starting temperature of the intermediate layer composition. By performing the molding under the above conditions, an intermediate layer having a uniform thickness can be formed.

It is noted that the molding temperature means the highest temperature where the temperature at the surface of the concave portion of the lower mold reaches from closing the mold to opening the mold. In addition, the flow starting temperature of the composition may be measured using the thermoplastic resin composition in a pellet form under the following conditions with “Flow Tester CFT-500” available from Shimadzu Corporation.

Measuring conditions: plunger area: 1 cm², die length: 1 mm, die diameter: 1 mm, load: 588.399 N, starting temperature: 30° C., and temperature increase rate: 3° C./min.

The diameter of the spherical core is preferably 34.8 mm or more, more preferably 35.7 mm or more, and even more preferably 36.6 mm or more, and is preferably 42.2 mm or less, more preferably 41.8 mm or less, even more preferably 41.2 mm or less, and most preferably 40.8 mm or less. If the spherical core has a diameter of 34.8 mm or more, the thickness of the cover does not become too thick and thus the resilience becomes better. On the other hand, if the spherical core has a diameter of 42.2 mm or less, the thickness of the cover does not become too thin and thus the cover functions better.

### (Construction of Golf Ball)

The construction of the golf ball is not particularly limited, as long as the golf ball has a spherical core and a cover covering the spherical core. Examples of the construction of the golf ball include a two-piece golf ball composed of a single layered spherical core and a cover covering the spherical core; a three-piece golf ball composed of a spherical core and a cover covering the spherical core, wherein the spherical core is composed of a center and one intermediate layer covering the center; and a multi-piece golf ball composed of a spherical core and a cover covering the spherical core, wherein the spherical core is composed of a center and at least two intermediate layers covering the center.

The embodiment for molding the cover from the cover composition is not particularly limited, and examples thereof include an embodiment comprising injection molding the cover composition directly onto the spherical core; and an embodiment comprising molding the cover composition into hollow shells, covering the spherical core with a plurality of the hollow shells and compression molding the spherical core with a plurality of the hollow shells (preferably an embodiment comprising molding the cover composition into half hollow-shells, covering the spherical core with two of the half hollow-shells and compression molding the spherical core with two of the half hollow-shells). After the cover is molded, the obtained golf ball body is ejected from the mold, and as necessary, the golf ball body is preferably subjected to surface treatments such as deburring, cleaning, and sandblast. If desired, a mark may be formed.

The thickness of the cover is preferably 0.3 mm or more, more preferably 0.4 mm or more, and even more preferably 0.5 mm or more, and is preferably 2.0 mm or less, more preferably 1.8 mm or less, and even more preferably 1.6 mm or less. If the thickness of the cover is 0.3 mm or more, the cover is easily molded, and if the thickness of the cover is 2.0 mm or less, the resilience performance of the golf ball becomes better since the core has a relatively large diameter.

The total number of dimples formed on the cover is preferably 200 or more and 500 or less. If the total number is less than 200, the dimple effect is hardly obtained. On the other hand, if the total number exceeds 500, the dimple effect is hardly obtained because the size of the respective dimples is small. The shape (shape in a plan view) of dimples includes, for example, without limitation, a circle, a polygonal shape such as a roughly triangular shape, a roughly quadrangular shape, a roughly pentagonal shape, a roughly hexagonal shape, and other irregular shapes. The shape of dimples is employed solely or at least two of them may be used in combination.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 7 μm or more, and even more preferably 9 μm or more, and is preferably 50 μm or less, more preferably 40 μm or less, and even more preferably 30 μm or less. If the thickness of the paint film is 5 μm or more, the paint film hardly wears off even if the golf ball is used continuously, and if the thickness of the paint film is 50 μm or less, the dimple effect is fully obtained.

The golf ball preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

When the golf ball according to the present disclosure has a diameter in the range of from 40 mm to 45 mm, the compression deformation amount (shrinking amount along the compression direction) of the golf ball when applying a load from an initial load of 98 N to a final load of 1275 N to the golf ball is preferably 2.0 mm or more, more preferably 2.4 mm or more, and even more preferably 2.5 mm or more, and is preferably 5.0 mm or less, more preferably 4.5 mm or less, and even more preferably 4.0 mm or less. If the compression deformation amount is 2.0 mm or more, the golf ball does not become too hard and thus the shot feeling thereof becomes better. On the other hand, if the compression deformation amount is 5.0 mm or less, the resilience of the golf ball becomes higher.

The FIGURE shows one example of a golf ball according to the present disclosure. The FIGURE is a partially cutaway cross-sectional view showing a golf ball 1 according to one embodiment of the present disclosure. The golf ball 1 comprises a spherical core 2, and a cover 3 covering the spherical core 2, wherein the spherical core 2 is composed of a center 21 and an intermediate layer 22 covering the center 21. A plurality of dimples 31 are formed on the surface of the cover 3. Other portions than the dimples 31 on the surface of the golf ball are lands 32. The golf ball 1 is provided with a paint layer and a mark layer on an outer side of the cover 3, but these layers are not depicted.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### Evaluation Method

### (1) Slab Hardness (Shore D Hardness)

Sheets with a thickness of about 2 mm were produced by injection molding the intermediate layer composition, thermoplastic polyurethane or cover composition. The sheets were stored at 23° C. for two weeks. At least three of these sheets were stacked on one another so as not to be affected by the measuring substrate on which the sheets were placed, and the hardness of the stack was measured with an automatic hardness tester (Digitest II available from Bareiss company) using a detector of “Shore D”.

### (2) Melt Viscosity

The melt viscosity of the sample in a pellet form was measured with a flow characteristic evaluating device (Flow Tester CFT-500D available from Shimadzu Corporation), and evaluated according to the following evaluation standard.

The measuring conditions were as follows: a die length: 10 mm, a die hole diameter: 1 mm, a cylinder pressure: 3 MPa, and a temperature: 190° C.
E (Excellent): less than 3500 Pa·s
G (Good): 3500 Pa·s or more and less than 3850 Pa·s
P (Poor): 3850 Pa·s or more

### (3) Flow Starting Temperature

The flow starting temperature of the sample in a pellet form was measured with a flow characteristic evaluating device (Flow Tester CFT-500D available from Shimadzu Corporation), and evaluated according to the following evaluation standard.

The measuring conditions were as follows: a plunger area: 1 cm², a die length: 1 mm, a load: 588.399 N, a starting temperature: 30° C., and a temperature elevating rate: 3° C./min.
E (Excellent): less than 109° C.
G (Good): 109° C. or more and less than 110° C.
P (Poor): 110° C. or more

### (4) Abrasion Resistance

A commercially available pitching wedge was installed on a swing robot, and two different locations of the golf ball were hit once respectively and totally two times at a head speed of 36 m/s. The hit portions of the two locations were visually observed, and ranked into five levels according to the following standard, and the worse result was adopted as the evaluation result. There was a case that the abrasion resistance was not evaluated, because the cover with the predetermined thickness could not be molded. This case was indicated as “P (Poor)”.

Five points: Substantially no abrasion is recognized.

Four points: No abrasion is recognized when the golf ball is visually observed, but a slight abrasion is recognized when the golf ball is carefully observed on the hand.
Three points: There is an abrasion that can be visually confirmed.
Two points: There is a conspicuous abrasion.
One point: There is a severe abrasion that makes the golf ball cannot be reused.

### [Production of Golf Ball]

### (1) Preparation of Rubber Composition

According to the formulations shown in Table 1, the materials were kneaded with a kneading roll to obtain the rubber compositions.

TABLE 1
Rubber composition

| | | |
|---|---|---|
| Formulation | BR730 | 100 |
| (parts by mass) | ZN-DA90S | 29.4 |
| | Zinc oxide | 5 |
| | Barium sulfate | Appropriate amount*¹⁾ |
| | PBDS | 0.4 |
| | Dicumyl peroxide | 0.7 |

*¹⁾The amount of barium sulfate was adjusted such that the golf balls had a mass of 45.6 g.

The materials used in Table 1 are shown as follows.
BR730: high-cis polybutadiene rubber (cis-1,4 bond amount=95 mass %, 1,2-vinyl bond amount=1.3 mass %, Moony viscosity (ML₁₊₄ (100° C.))=55, molecular weight distribution (Mw/Mn)=3) available from JSR Corporation
ZN-DA90S: zinc acrylate (containing zinc stearate in an amount of 10%) available from Nisshoku Techno Fine Chemical Co., Ltd.
Zinc oxide: “Ginrei R” available from Toho Zinc Co., Ltd.
Barium sulfate: “Barium sulfate BD” available from Sakai Chemical Industry Co., Ltd.
PBDS: bis(pentabromophenyl) disulfide available from Kawaguchi Chemical Industry Co., Ltd.
Dicumyl peroxide: available from Tokyo Chemical Industry Co. Ltd.

### (2) Preparation of Intermediate Layer Composition

According to the formulations shown in Table 2, the materials were extruded with a twin-screw kneading type extruder to prepare the intermediate layer compositions in a pellet form.

TABLE 2
Intermediate layer composition

| | | |
|---|---|---|
| Formulation | Surlyn 8150 | 50 |
| (parts by mass) | Himilan AM7329 | 50 |
| | Titanium dioxide | 4 |

| | |
|---|---|
| Slab hardness (Shore D) | 68 |

Surlyn (registered trademark) 8150: sodium ion neutralized ethylene-methacrylic acid copolymer ionomer resin available from Dow Chemical Company
Himilan (registered trademark) AM7329: zinc ion neutralized ethylene-methacrylic acid copolymer ionomer resin available from Dow-Mitsui Polychemicals Co., Ltd.
Titanium dioxide: A-220 available from Ishihara Sangyo Kaisha, Ltd.

### (3) Preparation of Cover Composition

The thermoplastic polyurethane was synthesized as follows.

Polytetramethylene ether glycol (PTMG (number average molecular weight: 1400)) heated to 80° C. was charged to dicyclohexylmethane diisocyanate (H₁₂MDI) heated to 80° C., and dibutyltin dilaurate was further charged in an amount of 0.005 mass % of the total amount of the raw materials (H₁₂MDI, PTMG and BD). Then, the mixture was stirred at 80° C. for 2 hours under a nitrogen stream. Next, butane diol (BD) heated to 80° C. was charged and then stirred at 80° C. for 1 minute under a nitrogen stream. Then, the reaction liquid was cooled, and the pressure was reduced at room temperature for 1 minute to conduct the system degasification. The degassed reaction liquid was spread in the container, and stored at 110° C. for 6 hours under a nitrogen atmosphere to conduct the urethane-forming reaction, thereby obtaining the thermoplastic polyurethane. It is noted that the mola ratio of PTMG, H₁₂MDI and BD was PTMG: H₁₂MDI: BD=1:3.81:2.81. The obtained thermoplastic polyurethane had a slab hardness of 31 in Shore D hardness.

Next, according to the formulations shown in Table 3 to 6, the materials including the thermoplastic polyurethane obtained above were extruded with a twin-screw kneading type extruder to prepare the cover compositions in a pellet form.

### (4) Production of Golf Ball

Golf balls No. 1 to 32

The rubber composition was heat-pressed in upper and lower molds, each having a hemispherical cavity, to obtain the centers having a diameter of 38.5 mm or 37.9 mm. It is noted that barium sulfate was added in an appropriate amount such that the obtained golf balls had a mass of 45.6 g.

The intermediate layer composition was injection molded on the centers to obtain the spherical cores. The thickness of the intermediate layer was 1.6 mm. The obtained spherical cores were charged into a final mold provided with a plurality of pimples on the cavity surface.

The cover composition was compression molded to obtain the half shells. The spherical cores were charged into the final mold, and covered with two of the half shells to obtain the golf balls having a plurality of dimples formed on the cover, wherein the dimples had an inverted shape of the pimples on the cavity surface. The evaluation results regarding the obtained golf balls were shown in Tables 3 and 4.

### Golf Balls No. 33 to 63

The rubber composition was heat-pressed in upper and lower molds, each having a hemispherical cavity, to obtain the centers having a diameter of 37.2 mm or 36.6 mm. It is noted that barium sulfate was added in an appropriate amount such that the obtained golf balls had a mass of 45.6 g.

The intermediate layer composition was injection molded on the centers to obtain the spherical cores. The thickness of the intermediate layer was 1.6 mm. The obtained spherical cores were charged into a final mold provided with a plurality of pimples on the cavity surface. The cover composition was injection molded on the spherical cores to obtain the golf balls having a plurality of dimples formed on the cover, wherein the dimples had an inverted shape of the pimples on the cavity surface. The evaluation results regarding the obtained golf balls were shown in Tables 5 and 6.

TABLE 3

| Golf ball No. | | | | 1 | 2 | 3 | 4 | 5 | 6 | 7 | 8 |
|---|---|---|---|---|---|---|---|---|---|---|---|
| Spherical core | | Diameter (mm) | | 41.7 | 41.7 | 41.7 | 41.7 | 41.7 | 41.7 | 41.7 | 41.7 |
| Cover | No. | | | 1 | 2 | 3 | 4 | 5 | 6 | 7 | 8 |
| composition | Formulation | (A) | Thermoplastic | 99.9 | 99.0 | 97.0 | 95.0 | 90.0 | 70.0 | 60.0 | 50.0 |
| | (parts | | polyurethane | | | | | | | | |
| | by mass) | (B) | N2050H | 0.1 | 1.0 | 3.0 | 5.0 | 10.0 | 30.0 | 40.0 | 50.0 |
| | | | N2060 | — | — | — | — | — | — | — | — |
| | | | N1050H | — | — | — | — | — | — | — | — |
| | | Himilan 1605 | | — | — | — | — | — | — | — | — |
| | | Himilan AM7329 | | — | — | — | — | — | — | — | — |
| | | Titanium dioxide | | 4 | 4 | 4 | 4 | 4 | 4 | 4 | 4 |
| | Slab hardness (Shore D) | | | 31 | 31 | 31 | 31 | 32 | 34 | 34 | 34 |
| | Evaluation | Melt viscosity | | G | E | E | E | E | E | E | E |
| | | Flow starting temperature | | G | G | G | E | E | E | E | E |
| Cover | Thickness (mm) | | | 0.5 | 0.5 | 0.5 | 0.5 | 0.5 | 0.5 | 0.5 | 0.5 |
| | Abrasion resistance performance | | | 4 | 4 | 4 | 4 | 4 | 3 | 3 | 2 |
| Golf ball No. | | | | 9 | 10 | 11 | 12 | 13 | 14 | 15 | 16 |
| Spherical core | | Diameter (mm) | | 41.7 | 41.7 | 41.7 | 41.7 | 41.7 | 41.7 | 41.7 | 41.7 |
| Cover | No. | | | 9 | 10 | 11 | 12 | 13 | 14 | 15 | 16 |
| composition | Formulation | (A) | Thermoplastic | 90.0 | 70.0 | 50.0 | 90.0 | 70.0 | 100 | 50.0 | 90.0 |
| | (parts | | polyurethane | | | | | | | | |
| | by mass) | (B) | N2050H | — | — | — | — | — | — | — | — |
| | | | N2060 | 10.0 | 30.0 | 50.0 | — | — | — | — | — |
| | | | N1050H | — | — | — | 10.0 | 30.0 | — | — | — |

| | Himilan 1605 | — | — | — | — | — | — | 25.0 | 5.0 |
|---|---|---|---|---|---|---|---|---|---|
| | Himilan AM7329 | — | — | — | — | — | — | 25.0 | 5.0 |
| | Titanium dioxide | 4 | 4 | 4 | 4 | 4 | 4 | 4 | 4 |
| Slab hardness (Shore D) | | 32 | 34 | 35 | 32 | 34 | 31 | 37 | 33 |
| Evaluation | Melt viscosity | E | E | E | E | E | P | E | G |
| | Flow starting temperature | E | E | E | E | E | P | E | G |

| | | | | | | | | | |
|---|---|---|---|---|---|---|---|---|---|
| Cover | Thickness (mm) | 0.5 | 0.5 | 0.5 | 0.5 | 0.5 | 0.5 | 0.5 | 0.5 |
| | Abrasion resistance performance | 4 | 3 | 2 | 4 | 3 | 4 | 1 | 2 |

TABLE 4

| Golf ball No. | | | | 17 | 18 | 19 | 20 | 21 | 22 | 23 | 24 |
|---|---|---|---|---|---|---|---|---|---|---|---|
| Spherical core | | Diameter (mm) | | 41.1 | 41.1 | 41.1 | 41.1 | 41.1 | 41.1 | 41.1 | 41.1 |
| Cover | No | | | 1 | 2 | 3 | 4 | 5 | 6 | 7 | 8 |
| composition | Formulation | (A) | Thermoplastic | 99.9 | 99.0 | 97.0 | 95.0 | 90.0 | 70.0 | 60.0 | 50.0 |
| | (parts | | polyurethane | | | | | | | | |
| | by mass) | (B) | N2050H | 0.1 | 1.0 | 3.0 | 5.0 | 10.0 | 30.0 | 40.0 | 50.0 |
| | | | N2060 | — | — | — | — | — | — | — | — |
| | | | N1050H | — | — | — | — | — | — | — | — |
| | | Himilan 1605 | | — | — | — | — | — | — | — | — |
| | | Himilan AM7329 | | — | — | — | — | — | — | — | — |
| | | Titanium dioxide | | 4 | 4 | 4 | 4 | 4 | 4 | 4 | 4 |
| | Slab hardness (Shore D) | | | 31 | 31 | 31 | 31 | 32 | 34 | 34 | 34 |
| | Evaluation | Melt viscosity | | G | E | E | E | E | E | E | E |
| | | Flow starting temperature | | G | G | G | E | E | E | E | E |
| Cover | Thickness (mm) | | | 0.8 | 0.8 | 0.8 | 0.8 | 0.8 | 0.8 | 0.8 | 0.8 |
| | Abrasion resistance performance | | | 4 | 4 | 4 | 4 | 4 | 3 | 3 | 3 |
| Golf ball No. | | | | 25 | 26 | 27 | 28 | 29 | 30 | 31 | 32 |
| Spherical core | | Diameter (mm) | | 41.1 | 41.1 | 41.1 | 41.1 | 41.1 | 41.1 | 41.1 | 41.1 |
| Cover | No. | | | 9 | 10 | 11 | 12 | 13 | 14 | 15 | 16 |
| composition | Formulation | (A) | Thermoplastic | 90.0 | 70.0 | 50.0 | 90.0 | 70.0 | 100 | 50.0 | 90.0 |
| | (parts | | polyurethane | | | | | | | | |
| | by mass) | (B) | N2050H | — | — | — | — | — | — | — | — |
| | | | N2060 | 10.0 | 30.0 | 50.0 | — | — | — | — | — |
| | | | N1050H | — | — | — | 10.0 | 30.0 | — | — | — |

| | Himilan 1605 | — | — | — | — | — | — | 25.0 | 5.0 |
|---|---|---|---|---|---|---|---|---|---|
| | Himilan AM7329 | — | — | — | — | — | — | 25.0 | 5.0 |
| | Titanium dioxide | 4 | 4 | 4 | 4 | 4 | 4 | 4 | 4 |
| Slab hardness (Shore D) | | 32 | 34 | 35 | 32 | 34 | 31 | 37 | 33 |
| Evaluation | Melt viscosity | E | E | E | E | E | P | E | G |
| | Flow starting temperature | E | E | E | E | E | P | E | G |

| | | | | | | | | | |
|---|---|---|---|---|---|---|---|---|---|
| Cover | Thickness (mm) | 0.8 | 0.8 | 0.8 | 0.8 | 0.8 | 0.8 | 0.8 | 0.8 |
| | Abrasion resistance performance | 4 | 3 | 2 | 4 | 3 | 4 | 1 | 2 |

TABLE 5

| Golf ball No. | | | | 33 | 34 | 35 | 36 | 37 | 38 | 39 |
|---|---|---|---|---|---|---|---|---|---|---|
| Spherical core | | Diameter (mm) | | 40.4 | 40.4 | 40.4 | 40.4 | 40.4 | 40.4 | 40.4 |
| Cover | No. | | | 2 | 3 | 4 | 5 | 6 | 7 | 8 |
| composition | Formulation | (A) | Thermoplastic | 99.0 | 97.0 | 95.0 | 90.0 | 70.0 | 60.0 | 50.0 |
| | (parts | | polyurethane | | | | | | | |
| | by mass) | (B) | N2050H | 1.0 | 3.0 | 5.0 | 10.0 | 30.0 | 40.0 | 50.0 |
| | | | N2060 | — | — | — | — | — | — | — |
| | | | N1050H | — | — | — | — | — | — | — |

| | Himilan 1605 | — | — | — | — | — | — | — |
|---|---|---|---|---|---|---|---|---|
| | Himilan AM7329 | — | — | — | — | — | — | — |
| | Titanium dioxide | 4 | 4 | 4 | 4 | 4 | 4 | 4 |
| Slab hardness (Shore D) | | 31 | 31 | 31 | 32 | 34 | 34 | 34 |
| Evaluation | Melt viscosity | E | E | E | E | E | E | E |
| | Flow starting temperature | G | G | E | E | E | E | E |

| | | | | | | | | |
|---|---|---|---|---|---|---|---|---|
| Cover | Thickness (mm) | 1.15 | 1.15 | 1.15 | 1.15 | 1.15 | 1.15 | 1.15 |
| | Abrasion resistance performance | 4 | 4 | 4 | 4 | 3 | 3 | 3 |

| Golf ball No. | | | | 40 | 41 | 42 | 43 | 44 | 45 | 46 | 47 |
|---|---|---|---|---|---|---|---|---|---|---|---|
| Spherical core | | Diameter (mm) | | 40.4 | 40.4 | 40.4 | 40.4 | 40.4 | 40.4 | 40.4 | 40.4 |
| Cover | No. | | | 9 | 10 | 11 | 12 | 13 | 14 | 15 | 16 |
| composition | Formulation | (A) | Thermoplastic | 90.0 | 70.0 | 50.0 | 90.0 | 70.0 | 100 | 50.0 | 90.0 |
| | (parts | | polyurethane | | | | | | | | |
| | by mass) | (B) | N2050H | — | — | — | — | — | — | — | — |
| | | | N2060 | 10.0 | 30.0 | 50.0 | — | — | — | — | — |
| | | | N1050H | — | — | — | 10.0 | 30.0 | — | — | — |

| | Himilan 1605 | — | — | — | — | — | — | 25.0 | 5.0 |
|---|---|---|---|---|---|---|---|---|---|
| | Himilan AM7329 | — | — | — | — | — | — | 25.0 | 5.0 |
| | Titanium dioxide | 4 | 4 | 4 | 4 | 4 | 4 | 4 | 4 |
| Slab hardness (Shore D) | | 32 | 34 | 35 | 32 | 34 | 31 | 37 | 33 |
| Evaluation | Melt viscosity | E | E | E | E | E | P | E | G |
| | Flow starting temperature | E | E | E | E | E | P | E | G |

| | | | | | | | | | |
|---|---|---|---|---|---|---|---|---|---|
| Cover | Thickness (mm) | 1.15 | 1.15 | 1.15 | 1.15 | 1.15 | 1.15 | 1.15 | 1.15 |
| | Abrasion resistance performance | 4 | 3 | 2 | 4 | 3 | P | 1 | P |

TABLE 6

| Golf ball No. | | | | 48 | 49 | 50 | 51 | 52 | 53 | 54 | 55 |
|---|---|---|---|---|---|---|---|---|---|---|---|
| Spherical core | | Diameter (mm) | | 39.8 | 39.8 | 39.8 | 39.8 | 39.8 | 39.8 | 39.8 | 39.8 |
| Cover | No. | | | 1 | 2 | 3 | 4 | 5 | 6 | 7 | 8 |
| composition | Formulation | (A) | Thermoplastic | 99.9 | 99.0 | 97.0 | 95.0 | 90.0 | 70.0 | 60.0 | 50.0 |
| | (parts | | polyurethane | | | | | | | | |
| | by mass) | (B) | N2050H | 0.1 | 1.0 | 3.0 | 5.0 | 10.0 | 30.0 | 40.0 | 50.0 |
| | | | N2060 | — | — | — | — | — | — | — | — |
| | | | N1050H | — | — | — | — | — | — | — | — |

| | Himilan 1605 | — | — | — | — | — | — | — | — |
|---|---|---|---|---|---|---|---|---|---|
| | Himilan AM7329 | — | — | — | — | — | — | — | — |
| | Titanium dioxide | 4 | 4 | 4 | 4 | 4 | 4 | 4 | 4 |
| Slab hardness (Shore D) | | 31 | 31 | 31 | 31 | 32 | 34 | 34 | 34 |
| Evaluation | Melt viscosity | G | E | E | E | E | E | E | E |
| | Flow starting temperature | G | G | G | E | E | E | E | E |

| | | | | | | | | | |
|---|---|---|---|---|---|---|---|---|---|
| Cover | Thickness (mm) | 1.45 | 1.45 | 1.45 | 1.45 | 1.45 | 1.45 | 1.45 | 1.45 |
| | Abrasion resistance performance | 5 | 5 | 5 | 5 | 5 | 4 | 4 | 3 |

| Golf ball No. | | | | 56 | 57 | 58 | 59 | 60 | 61 | 62 | 63 |
|---|---|---|---|---|---|---|---|---|---|---|---|
| Spherical core | | Diameter (mm) | | 39.8 | 39.8 | 39.8 | 39.8 | 39.8 | 39.8 | 39.8 | 39.8 |
| Cover | No. | | | 9 | 10 | 11 | 12 | 13 | 14 | 15 | 16 |
| composition | Formulation | (A) | Thermoplastic | 90.0 | 70.0 | 50.0 | 90.0 | 70.0 | 100 | 50.0 | 90.0 |
| | (parts | | polyurethane | | | | | | | | |
| | by mass) | (B) | N2050H | — | — | — | — | — | — | — | — |
| | | | N2060 | 10.0 | 30.0 | 50.0 | — | — | — | — | — |
| | | | N1050H | — | — | — | 10.0 | 30.0 | — | — | — |

| | Himilan 1605 | — | — | — | — | — | — | 25.0 | 5.0 |
|---|---|---|---|---|---|---|---|---|---|
| | Himilan AM7329 | — | — | — | — | — | — | 25.0 | 5.0 |
| | Titanium dioxide | 4 | 4 | 4 | 4 | 4 | 4 | 4 | 4 |
| Slab hardness (Shore D) | | 32 | 34 | 35 | 32 | 34 | 31 | 37 | 33 |
| Evaluation | Melt viscosity | E | E | E | E | E | P | E | G |
| | Flow starting temperature | E | E | E | E | E | P | E | G |

| | | | | | | | | | |
|---|---|---|---|---|---|---|---|---|---|
| Cover | Thickness (mm) | 1.45 | 1.45 | 1.45 | 1.45 | 1.45 | 1.45 | 1.45 | 1.45 |
| | Abrasion resistance performance | 5 | 4 | 3 | 5 | 4 | 5 | 2 | 3 |

The materials used in Tables 3 to 6 are shown as follows.
N2050H: NUCREL (registered trademark) N2050H (acid amount: 20 mass %, MFR (190° C., 2.16 kgf): 500 g/10 min, melting point: 75° C. to 115° C.) available from Dow-Mitsui Polychemicals Co., Ltd.
N2060: NUCREL N2060 (acid amount: 20 mass %, MFR (190° C., 2.16 kgf): 60 g/10 min, melting point: 75° C. to 115° C.) available from Dow-Mitsui Polychemicals Co., Ltd.
N1050H: NUCREL N1050H (acid amount: 10 mass %, MFR (190° C., 2.16 kgf): 500 g/10 min, melting point: 75° C. to 115° C.) available from Dow-Mitsui Polychemicals Co., Ltd.
Himilan (registered trademark) 1605: sodium ion neutralized ethylene-methacrylic acid copolymer ionomer resin available from Dow-Mitsui Polychemicals Co., Ltd.
Himilan AM7329: zinc ion neutralized ethylene-methacrylic acid copolymer ionomer resin available from Dow-Mitsui Polychemicals Co., Ltd.
Titanium dioxide: A-220 available from Ishihara Sangyo Kaisha, Ltd.

The golf balls No. 1 to 13, 17 to 29, 33 to 44 and 48 to 60 comprise a cover formed from the cover compositions No. 1 to 13, wherein the cover compositions No. 1 to 13 contain (A) the thermoplastic polyurethane and (B) the olefin/unsaturated carboxylic acid copolymer and/or the olefin/unsaturated carboxylic acid/unsaturated carboxylic acid ester copolymer as the resin component, and an amount of (A) the thermoplastic polyurethane in the resin component is 50 mass % or more.

The golf balls No. 14, 30, 45 and 61 comprise a cover formed from the cover composition No. 14, wherein the cover composition No. 14 contains (A) the thermoplastic polyurethane as the resin component, and does not contain (B) the olefin/unsaturated carboxylic acid copolymer and/or the olefin/unsaturated carboxylic acid/unsaturated carboxylic acid ester copolymer.

The golf balls No. 15, 16, 31, 32, 46, 47, 62 and 63 comprise a cover formed from the cover composition No. 15 or 16, wherein the cover composition No. 15 or 16 contains (A) the thermoplastic polyurethane and an ionomer resin (a metal ion neutralized product of the olefin/unsaturated carboxylic acid copolymer or a metal ion neutralized product of the olefin/unsaturated carboxylic acid/unsaturated carboxylic acid ester copolymer).

The golf balls No. 1 to 32 are the cases that the cover was formed by using half shells produced from the cover composition by a compression molding method.

The cover compositions No. 1 to 13 for forming the covers of the golf balls No. 1 to 13 and 17 to 29 have a lower melt viscosity and a lower flow starting temperature than the cover composition No. 14 for forming the covers of the golf balls No. 14 and 30. Thus, the covers of these golf balls No. 1 to 13 and 17 to 29 have improved moldability.

In addition, the covers of the golf balls No. 1 to 13 and 17 to 29 have greater abrasion resistance than the covers of the golf balls No. 15 and 31, thus lowering in the abrasion resistance is suppressed by using (B) the olefin/unsaturated carboxylic acid copolymer and/or the olefin/unsaturated carboxylic acid/unsaturated carboxylic acid ester copolymer.

The golf balls No. 33 to 47 are the cases that the cover with a thickness of 1.15 mm was formed from the cover composition by an injection molding method.

The cover compositions No. 1 to 13 for forming the covers of the golf balls No. 33 to 44 have a lower melt viscosity and a lower flow starting temperature than the cover composition No. 14 for forming the cover of the golf ball No. 45. Thus, the covers of these golf balls No. 33 to 44 have improved moldability.

In addition, the covers of the golf balls No. 33 to 44 have greater abrasion resistance than the cover of the golf ball No. 46, thus lowering in the abrasion resistance is suppressed by using (B) the olefin/unsaturated carboxylic acid copolymer and/or the olefin/unsaturated carboxylic acid/unsaturated carboxylic acid ester copolymer.

The golf balls No. 48 to 63 are the cases that the cover with a thickness of 1.45 mm was formed from the cover composition by an injection molding method.

The cover compositions No. 1 to 13 for forming the covers of the golf balls No. 48 to 60 have a lower melt viscosity and a lower flow starting temperature than the cover composition No. 14 for forming the cover of the golf ball No. 61. Thus, the covers of these golf balls No. 48 to 60 have improved moldability.

In addition, the covers of the golf balls No. 48 to 60 have greater abrasion resistance than the cover of the golf ball No. 62, thus lowering in the abrasion resistance is suppressed by using (B) the olefin/unsaturated carboxylic acid copolymer and/or the olefin/unsaturated carboxylic acid/unsaturated carboxylic acid ester copolymer.

The present disclosure (1) is a golf ball comprising a spherical core and a cover covering the spherical core, wherein the cover is formed from a cover composition containing (A) a thermoplastic polyurethane and (B) an olefin/unsaturated carboxylic acid copolymer and/or an olefin/unsaturated carboxylic acid/unsaturated carboxylic acid ester copolymer as a resin component, and an amount of (A) the thermoplastic polyurethane is 50 mass % or more in the resin component.

The present disclosure (2) is the golf ball according to the present disclosure (1), wherein a mass ratio ((A)/(B)) of (A) the thermoplastic polyurethane to (B) the olefin/unsaturated carboxylic acid copolymer and the olefin/unsaturated carboxylic acid/unsaturated carboxylic acid ester copolymer in the resin component ranges from 50.0/50.0 to 99.9/0.1.

The present disclosure (3) is the golf ball according to the present disclosure (1), wherein a mass ratio ((A)/(B)) of (A) the thermoplastic polyurethane to (B) the olefin/unsaturated carboxylic acid copolymer and the olefin/unsaturated carboxylic acid/unsaturated carboxylic acid ester copolymer in the resin component ranges from 60.0/40.0 to 99.0/1.0.

The present disclosure (4) is the golf ball according to any one of the present disclosures (1) to (3), wherein (A) the thermoplastic polyurethane comprises an alicyclic diisocyanate and/or an aromatic diisocyanate as a polyisocyanate.

The present disclosure (5) is the golf ball according to the present disclosure (4), wherein the polyisocyanate includes at least one diisocyanate selected from the group consisting of 4,4′-dicyclohexylmethane diisocyanate, 1,3-bis(isocyanatomethyl)cyclohexane, isophorone diisocyanate, trans-1,4-cyclohexane diisocyanate, 4,4′-diphenylmethane diisocyanate and toluene diisocyanate.

This application is based on Japanese patent application No. 2024-052687 filed on Mar. 28, 2024, and Japanese patent application No. 2024-119487 filed on Jul. 25, 2024, the contents of which are hereby incorporated by reference.

1. A golf ball comprising a spherical core and a cover covering the spherical core, wherein
the cover is formed from a cover composition containing (A) a thermoplastic polyurethane and (B) an olefin/unsaturated carboxylic acid copolymer and/or an olefin/unsaturated carboxylic acid/unsaturated carboxylic acid ester copolymer as a resin component, and
an amount of (A) the thermoplastic polyurethane is 50 mass % or more in the resin component.

2. The golf ball according to claim 1, wherein a mass ratio ((A)/(B)) of (A) the thermoplastic polyurethane to (B) the olefin/unsaturated carboxylic acid copolymer and the olefin/unsaturated carboxylic acid/unsaturated carboxylic acid ester copolymer in the resin component ranges from 50.0/50.0 to 99.9/0.1.

3. The golf ball according to claim 1, wherein a mass ratio ((A)/(B)) of (A) the thermoplastic polyurethane to (B) the olefin/unsaturated carboxylic acid copolymer and the olefin/unsaturated carboxylic acid/unsaturated carboxylic acid ester copolymer in the resin component ranges from 60.0/40.0 to 99.0/1.0.

4. The golf ball according to claim 1, wherein (A) the thermoplastic polyurethane comprises an alicyclic diisocyanate and/or an aromatic diisocyanate as a polyisocyanate constituting (A) the thermoplastic polyurethane.

5. The golf ball according to claim 4, wherein the polyisocyanate includes at least one diisocyanate selected from the group consisting of 4,4′-dicyclohexylmethane diisocyanate, 1,3-bis(isocyanatomethyl)cyclohexane, isophorone diisocyanate, trans-1,4-cyclohexane diisocyanate, 4,4′-diphenylmethane diisocyanate and toluene diisocyanate.

6. The golf ball according to claim 1, wherein the cover composition has a slab hardness ranging from 25 to 40 in Shore D hardness.

7. The golf ball according to claim 1, wherein the cover composition has a melt viscosity (190° C.) of less than 3,850 Pa·s.

8. The golf ball according to claim 1, wherein the cover composition has a flow starting temperature of less than 110° C.

9. The golf ball according to claim 1, wherein (B) the olefin/unsaturated carboxylic acid copolymer and/or the olefin/unsaturated carboxylic acid/unsaturated carboxylic acid ester copolymer has a melt flow rate (MFR) (190° C., 2.16 kgf) of 10 g/10 min or more.

10. The golf ball according to claim 1, wherein (B) the olefin/unsaturated carboxylic acid copolymer and/or the olefin/unsaturated carboxylic acid/unsaturated carboxylic acid ester copolymer has a melting point of 120° C. or less.

11. The golf ball according to claim 1, wherein a total amount of (A) the thermoplastic polyurethane and (B) the olefin/unsaturated carboxylic acid copolymer and/or the olefin/unsaturated carboxylic acid/unsaturated carboxylic acid ester copolymer is 85 mass % or more in the resin component.

12. The golf ball according to claim 1, wherein the resin component of the cover composition consists of (A) the thermoplastic polyurethane and (B) the olefin/unsaturated carboxylic acid copolymer and/or the olefin/unsaturated carboxylic acid/unsaturated carboxylic acid ester copolymer.
